(19) United States
(12) Patent Application Publication
(10) Pub. No.: US 2008/0183027 A1
(43) Pub. Date: Jul. 31, 2008

(54) Description of the global warming control system

(76) Inventor: John Yuming Liu, Fresh Meadows, NY (US)

Correspondence Address: John Yuming Liu, 69-57, 180 St., Fresh Meadows, NY, 11365, US

(21) Appl. No.: 11/698,235

(22) Filed: Jan. 26, 2007

(51) Int. Cl. A62D 3/00

(52) U.S. Cl. 588/300; 588/405

(57) ABSTRACT

It is a system to absorb the CO2 and release the oxygen (O2). We construct the mechanical and electrical instrument. We use solar panel to produce electrical power in DC. We add DC motors attached with rechargeable battery and solar panel. The motor will generate the current and bubbles to make air contact with sea water with dead zone in ocean (desert in ocean). We define the module which is independent platform will have the solar panel, rechargeable battery, 12 or 24 voltage, dc motor, anchor and current guide, bubbles generator. By this platform we can perform the photosynthesis to diminish CO2 and release the oxygen (O2). We can build many platforms to diminish CO2 and we are able to control global warming. We also establish the communication center to locate the position of the platforms. The fish farmland is created through the plankton which is created by the motion of the motor,

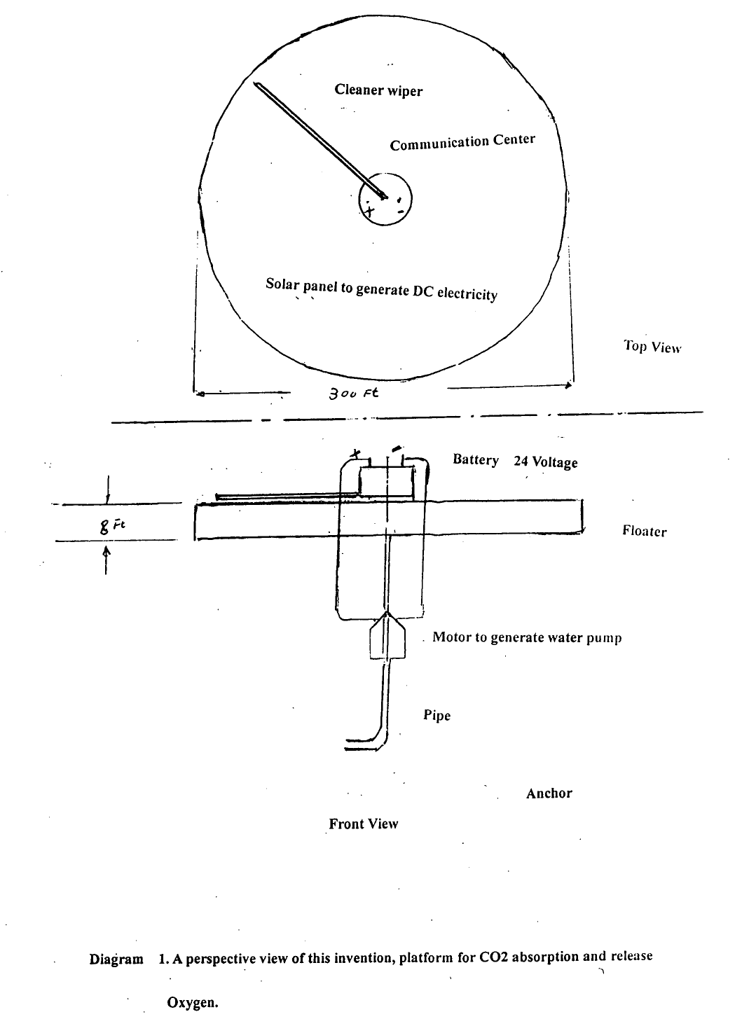

This invention is related with global warming. We have to construct the platform. (see Diagram 1). How to diminish CO2? It is essential for global warming to diminish CO2. We understand that there are plenty of water, CO2 and water current moving generated by electricity from solar panel. The chemical reaction will perform as the following.

CO2+H2O+sun light→O2+CHO (food) such as Plankton grows.

Whence the ocean water is slightly moving, the plankton will proceed the photosynthesis and release the oxygen and absorb the CO2. We can arrange the platform in such a way to generate the current which will flow the direction as we decides. Also the size of the platform is large enough to make current to vary the major current of the ocean. Maybe we can modify the meteorology to some extend. We can modify the ocean current in order to modify the weather. Because of el Nino effect, which affect the warm winter for some area. We can use this platform to modify the current in order to modify the weather.

This platform is following the nature to construct. Solar panel will generate the electrical power. We use the electrical power (direct current) to drive the motor which will drive the water current and push air into sea water. The sea water will absorb the oxygen and CO2. The oxygen will provide the life of the creature (fish etc.). The CO2 will be the element of the Photosynthesis. The Wiper will turn 1 or 2 turns per hours. The floater will keep the whole platform out of sea water about 1 or 2 inches. We have the recharge battery above platform to maintain the 24-hour operation per day, 365 days a year. Underneath is a motor to pump sea water which is guided to the direction what we want and push the air into sea water. We can use the direction of the sea water current to modify the current of el Nino or la Nina in order to modify the weather. Anchor is used to position the location. Anchor can be replaced by pushed water current. The position can be located by GPS via satellite. The communication among the platforms will be established and the position is located. The fish farmland will be created due to the plankton. The plankton will grow with the motion of the sea water created by water pump which is drove by solar panel. There are five oceans in the world such as Atlantic ocean, Pacific ocean, Indian Ocean, Arctic Ocean, and Antarctic Ocean. Around the center of the ocean current, it is calm, no motion. It is a dead zone. We can use this invention to active this dead zone. Also we can use this invention to change the dead zone in the lake for fresh water.

### BRIEF DESCRIPTION OF THE DIAGRAMS

Diagram 1. Platform of global warm control system.

Solar panel, Clean wiper, recharge battery, floater, motor and pipe, anchor and communication center.

The invention of the claimed are:

1. Platform equipped with solar panel, rechargeable battery, dc motor, current guides, anchor bubble generator, and communication center
